(19) United States
(12) Patent Application Publication
(10) Pub. No.: US 2002/0155208 A1
(43) Pub. Date: Oct. 24, 2002

(54) Food product comprising protein coated gas microbubbles

(75) Inventors: Jan Benjamins, Vlaardingen (NL); Arjen Sein, Vlaardingen (NL); Cornelis Van Vliet, Vlaardingen (NL)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/058,467

(22) Filed: Jan. 28, 2002

(30) Foreign Application Priority Data
Jan. 30, 2001 (EP) 01200309.1

(51) Int. Cl. A23L 1/00

(52) U.S. Cl. 426/564; 426/565

(57) ABSTRACT

A food product is described comprising an aqueous phase and gas microbubbles substantially dispersed in the aqueous phase which gas microbubbles have coating and a mean diameter size distribution with a maximum below 10 μm, wherein the coating substantially consists of protein, wherein the pH of the aqueous phase is from 2.5 to 6.0.

### DESCRIPTION

1. Field of the Invention

The invention relates to a food product comprising an aqueous phase and gas microbubbles, and to a process for the preparation thereof. The invention especially relates to a food product in the form of an emulsion of an aqueous phase and a fatty phase, which emulsion comprises gas microbubbles.

2. Background of the Invention

Food products comprising an aqueous phase and gas bubbles are known. One reason for incorporation of gas bubbles in food products is to give the food product an airy texture, for example in ice cream, bread and dairy products. In food products in the form of emulsions, the presence of gas bubbles may avoid phase separation. When the emulsions are used as shallow frying products, gas bubbles may reduce spattering.

FR-A-7040472 discloses that the separation of a liquid margarine into two phases can also be at least partly overcome by incorporation of gas microbubbles into said margarine. The size of the gas microbubble is preferably between 1 and 25 μm; most preferred 2-10 μm. In the liquid margarine product, gas is present in the oil phase.

WO 94/12063 discloses the use of gas cells in food products. Food products such as low fat spreads are disclosed, said products comprising gas cells and having a thermodynamic stability in excess of 2 weeks. More than 90% by number of the gas cells in said products have an average D3,2 particle size of less than 20 μm, most preferred 0.5 to 3 μm. The gas cells are prepared by application of high shear to the product or a pre mix.

WO 00/038547 discloses a food product comprising an aqueous phase and gas microbubbles, wherein the gas microbubbles are substantially dispersed in the aqueous phase and the gas microbubbles have at least a partial coating and a mean diameter size distribution with a maximum below 10 μm. The coating may be a protein, e.g. bovine serum albumin. WO 00/038547 therefore discloses a food product with protein coated gas microbubbles.

The food product according to WO 00/038547, when used as frying product for shallow frying, shows reduced spattering behaviour, compared to the same product without gas microbubbles. The SV1 and SV2 values as defined hereunder reported in the examples of WO 00/038547 are 7 to 9 for SV1 and 5.5 to 7 for SV2, on a scale of 0-10. Although these SV values are acceptable, still an improvement is possible. Moreover we have found that SV values, in particular SV2, decrease during storage of the food product. Already after a few days storage time, the anti-spattering performance is notably decreased. The storage stability, with respect to anti-spattering performance needs to be improved.

### SUMMARY OF THE INVENTION

An object of the invention is to improve the anti-spattering performance of the prior art food products, in particular to improve the storage stability, with respect to anti-spattering performance.

This object is attained by the food product according to the invention, wherein the pH of the aqueous phase is from 2.5 to 6.0.

Other objects for the invention are to provide food products, which comprise gas microbubbles, in which the gas microbubbles have a long-term stability in the product.

In a preferred embodiment, the protein is one or more globular proteins. More preferably the protein is one or more albumins transferrins or glycinin.

In further preferred embodiments the protein is serum albumin and the pH of the aqueous phase is from 2.5 to 4.8, the protein is egg white protein and the pH of the aqueous phase is from 3.5 to 4.1 or the protein is soy glycinin 11S and the pH of the aqueous phase is from 2.5 to 6.0.

### DETAILED DESCRIPTION OF THE INVENTION

The following definitions will be used throughout the description and claims. Where ranges are mentioned, the expression from a to b is meant to indicate from and including a, up to and including b, unless indicated otherwise. The term's ‘oil’ and ‘fat’ are used interchangeably. The term gas microbubbles refers to individual gas units, which are all part of a dispersed gas phase. Gas microbubbles are herein defined as gas bubbles which have a mean diameter size distribution with a maximum below 10 μm. Coated gas microbubbles are herein defined as gas microbubbles having a coating and a mean diameter with a maximum below 10 μm (including the thickness of the coating). Mean diameters are herein defined as D(3,3) and may be determined as given under examples. Gas microbubbles in the aqueous phase are considered to be part of the aqueous phase, such that for instance weight % aqueous phase includes the weight of the gas microbubbles in the aqueous phase. Pressures are expressed in bar (=10exp5 Pa) absolute pressure.

Soybean proteins are herein classified according to ultracentrifugal analysis into 2S, 7S, 11 S and 15S fractions, as described in Naismith, W. E. F., Biochem. Biophys. Acta 16 (1955), 203 and Wolf, W. J. and Briggs, D. R., Arch. Biochem. Biophys. 63 (1958), 377.

Egg white protein is herein defined to include crude egg white, ovalbumin, conalbumin, lysozyme.

Advantageously, the protein is whey protein. Whey protein coated gas microbubbles thus prepared have an improved stability, especially in the presence of emulsifiers.

Surprisingly, whey protein coated gas microbubbles show improved temperature stability, compared to other proteins that may be used to produce protein coated gas microbubbles coated with other proteins. The invention therefore further relates to protein coated gas microbubbles, wherein the coating of the microbubbles substantially consists of whey protein. Preferably, whey protein coated gas microbubbles are prepared from a solution or dispersion of a protein comprises 0.1-30 wt. % native whey protein and substantially no casein. Preferably the whey protein comprises a high concentration of β-lactoglobulin, for instance at least 20 wt. %, preferably at least 40 wt. %.

“Native whey protein” is herein defined as whey protein having a low amount of aggregates of whey protein. Such “native whey protein” may be characterised by the fact that it is soluble in water. Preferably the presence of non-water soluble whey products is avoided. The degree of denaturation of protein is determined herein by nitrogen solubility index (NSI) at pH 4.6 according to de Wit, J. N., G. Klarenbeek,& E. Hontelez-Backx: Evaluation of functional properties of whey protein concentrates and whey protein isolate 1. Isolation and characterization, Netherlands Milk and Dairy Journal 37, 37-49 (1983).

Casein should be essentially absent in the solution or dispersion of the whey protein, since casein interferes with the formation of protein coated gas microbubbles. The amount of casein should preferably be lower than 5 wt. % casein relative to the amount of whey protein, preferably less than 1 wt. %, more preferably below 0.5 wt. % casein. Casein peptides and/or fragments, for examples such as peptides produced in the proteolytically cleavage of casein, may be present.

Native whey protein may be used according to the invention as such or in the form of whey products that contain a substantial amount of native whey protein. Whey products containing a high amount of native whey protein are prepared in a process where heat treatment, causing denaturation of the whey protein has been essentially avoided, such as for instance a process using ultrafiltration. An example of a commercially available whey product with native whey protein is: Ultra whey-99 available from Volactive (United Kingdom) containing 94 wt. % protein.

Preferably the native whey protein used according to the invention comprises a low amount of lactose and fatty acid. More preferably, the lactose content is 10 wt. % or lower, most preferably 4 wt. % or lower.

The invention further relates to a process for the preparation of protein coated gas microbubbles, wherein a solution or dispersion of a protein is contacted with gas, characterised in that the solution or dispersion of a protein comprises 0.1-30 wt. % native whey protein, preferably 0.1-5 wt. % native whey protein, and substantially no casein.

Food products according to the invention comprise an aqueous phase and gas microbubbles. A second phase may be present, for example a fatty phase, a biopolymer phase or a phase comprising a gelling agent. Products with a biopolymer phase are for example disclosed in EP-A-547,647.

Preferred food products comprise a fat phase and an aqueous phase, they may e.g. comprise 0.1 to 99 wt %, preferably 30-99% fat based on the total weight of the food product. More preferred food products are emulsions of a fat phase and an aqueous phase. Such emulsions are for example spreads, dressings, sauces, ice-cream, margarines and margarine-like products, like liquid margarines. The emulsions may be oil continuous, water continuous or bicontinuous. In a preferred embodiment beverages are not included in the term ‘food product’.

In products according to the invention with a low to very low water content, the aqueous phase may substantially consist of gas microbubbles.

A preferred food product is a liquid margarine, i.e. a water in oil emulsion comprising generally from 1 to 40, preferably 5 to 30 wt. % water on total product weight.

In the preferred food products comprising a fat phase, the fat phase may comprise any triglyceride oil. A fat phase rich in triglycerides comprising (poly) unsaturated fatty acid residues is highly preferred. Therefore the fat is preferably selected from the group comprising sunflower oil, soybean oil, rapeseed oil, cottonseed oil, olive oil, corn oil, groundnut oil, or low melting butterfat fractions and/or combinations thereof. These fats may be partially hydrogenated. The fat phase may comprise sucrose polyesters.

Optionally the food product comprises in addition to these fats a hard fat component selected from the group comprising: hardened rapeseed oil, hardened soybean oil, hardened rapeseed oil, hardened cottonseed oil, hardened corn oil, hardened groundnut oil, palmoil, hardened palmoil, palmoil fractions, hardened palmoil fractions, butterfat or butterfat fractions. These fats are optionally partly or fully hydrogenated to obtain the desired structuring properties. This hard fat may serve to impart structure and or stability to the products.

In case the food product is a pourable liquid margarine, the amount of hard fat may be below 2 wt. %, or below 1 wt. %. Hard fat may be essentially absent in such products.

In water and oil emulsions according to the invention, water droplets forming the dispersed aqueous phase are preferably of a diameter of from 0,5 to about 40 μm, more preferably 1 to about 25 μm. The water droplets can comprise one or more gas microbubbles per droplet, depending on the relative size of the water droplet, compared to the size of the gas microbubbles.

For frying purposes, a water in oil emulsion with many gas microbubbles of relatively small size is preferred over a smaller amount of relatively bigger gas microbubbles. Each gas microbubble may serve as a nucleating site for evaporating water droplets and therefore the more sites the better.

Gas microbubbles comprised in products according to the invention, should be substantially dispersed in the aqueous phase of said food products. This means that preferably at least 50 vol. %, more preferably at least 70 vol. %, even more preferably at least 80 vol. %, most preferred 90-100 vol. % of all gas microbubbles are dispersed in the aqueous phase, whereas the remaining part of the gas microbubbles may be in another phase of the food product, for example in a fatty phase. Random distribution of gas microbubbles in for example margarine is known from EP-A-285,198, where most of the gas microbubbles are in the fat phase. It has been found that such products on the one hand still show spattering upon use as a shallow frying product and on the other hand often show instability upon storage.

The advantageous effects in reduced spattering and increased storage stability can only be obtained if the gas is dispersed in the form of small gas microbubbles, having a mean diameter size distribution with a maximum below 10 μm, preferably below 5 μm, more preferably below 3 μm, even more preferably below 2 μm, most preferred below 1 μm. A method to determine the mean diameter size distribution of said gas microbubbles is illustrated in the examples.

In a preferred embodiment a substantial part of the gas microbubbles is present in the form of aggregates, more preferably at least 80 wt. % of the gas microbubbles is present in the form of aggregates. We have found that such aggregates occur when the aqueous phase of the food product according to the invention comprises an amount of an edible salt chosen from group I or group II salts or ammonium salts. Advantageously the edible salt is chosen from group I or group II or ammonium halides, sulphates, phosphates or citrates. Most preferred salt is sodium chloride.

The amount of salt may be 0.1 to 10 wt. %, more preferably 0.1 to 5 wt. %, most preferably 0.5-2 wt. %, based on total weight of the food product.

In another preferred embodiment, at least 80 vol. % of the total volume of gas in food products according to the invention is present as gas microbubbles having a mean diameter size between 0.5 and 15 μm.

The gas microbubbles according to the invention have a coating, which partially and preferably totally covers the surface of the gas microbubbles. Said coating can also be explained as a shell, which totally or partially forms a border between the contents of the gas microbubble and its surroundings. This coating is believed to give a beneficial contribution to the stability of the gas microbubbles; i.e. it at least partly, or preferably substantially completely, prevents dissolving of the gas into liquid of the product, coalescence of the gas microbubbles and diffusion of the gas microbubbles out of the product.

The coating can be made visible by Confocal Scanning Light Miscroscopy (CSLM) techniques wherein a protein coating can be made visible by protein specific colouring with a fluorescent label. In general the coating is so condensed and comprises such high concentration of the coloured compound, that shells are easily distinguishable. The diameter of the gas microbubbles as defined herein is the diameter of the gas microbubble as such, without the thickness of the protein shell.

The total amount of gas present in the food product according to the invention was found to depend on the use that is envisaged. It is believed that it is within the capabilities of the skilled person to select the appropriate amount of gas. The vol. % of gas on aqueous phase can be determined by CSLM as described in the examples, or by measuring the density of an isolated aqueous phase, and comparing the measured density to the density of water free of incorporated gas microbubbles.

The gas microbubbles in the claimed products may comprise any non-toxic gas, preferably the gas is gaseous at room temperature. For example the gas is selected from the group consisting of inert gas such as nitrogen, helium, argon and the like, oxygen, carbon dioxide, fluorinated hydrocarbons and air. Highly preferred gasses are nitrogen, argon, oxygen, air and/or combinations thereof. Most preferred is air.

The stability of the gas microbubbles in the products according to the invention is preferably such that the total amount of gas microbubbles in the food product according to the invention, after storage at ambient temperature for a period of from 4 to 6 weeks is from 50 to 100% of the amount present directly after preparation, preferably from 80 to 100%, whereby the amount of gas microbubbles directly after preparation of said products is set to 100%.

Optionally the products according to the invention may comprise other gas microbubbles than the protein coated microbubbles according to the invention. Such gas microbubbles may have a size distribution with a maximum above 10 micrometer or they may be uncoated.

Food products according to the invention show reduced spattering upon preferred use in shallow frying. Shallow frying is frying wherein the food product to be fried is fried in a layer of frying product, i.e. the product is not completely immersed in the frying product. An example of shallow frying is frying of meat, fish or vegetables in a pan. On the contrary, in deep frying, the food product to be fried is usually completely immersed in the frying product. An example of deep frying is the frying of potato chips in a deep oil-filled frying pan.

During shallow frying with a frying product comprising an aqueous phase, such as margarine, generally spattering will occur in two instances, separated in time. A first type of spattering, generally referred to as primary spattering may occur when the margarine is heated in the frying pan. Primary spattering is a result of explosion-like evaporation of superheated water droplets, originating from the aqueous phase of the margarine. A second type of spattering occurs, when water, or a food product that releases water, such as meat, fish or vegetable is introduced into the heated frying product. This type of spattering, again due to explosive evaporation of superheated water, is called secondary spattering.

Values for primary spattering (SV1) and secondary spattering (SV2) are herein determined according to the method illustrated in the examples. The food products according to the invention show a primary spattering value SVl from 8 to 10, preferably from 9 to 10. The secondary spattering value SV2 for products according to the invention is preferably from 8-10.

The food products according to the invention may also be advantageously used in other uses than as shallow frying product.

Examples of food products according to the invention are spreads, e.g. margarines (water in oil or oil in water emulsions), mayonnaises (oil in water emulsions), dairy products such as fresh cheese (oil in water emulsions) and dressings (oil in water emulsions), ice cream, bread etc. In such products the advantages of the food products according to the invention may be an improved (airy) texture, an increased stability due to avoiding phase separation or other benefits.

In addition to the above-mentioned ingredients, food products according to the invention may optionally contain further ingredients suitable for use in these products. Examples of these materials are sugar or other sweetener materials, EDTA, spices, salts, bulking agents, egg yolk, emulsifiers, stabilising agents, flavouring materials, colouring materials, acids, preserving agents, vegetable particles etc. Other suitable ingredients that can be included in food products according to the invention are spattering reducing agents such as lecithin and salts or combinations thereof.

The food products according to the invention may be packaged in usual manner. Margarines may be packed in a wrapper, tub or in a bottle. Other food products may be packed in bottles, tins, foil, paper, etc. or sold as such.

Food products according to the invention may be prepared by a process for the preparation of a food product comprising the steps of:

a) preparing a mixture comprising protein and water

b) adjusting the pH of the mixture to a value within the range of 2.0 to 11.0

c) pre-incubating the mixture

d) subjecting the mixture to a sonication treatment

e) optionally, separating the product of step d) in a fraction rich in gas microbubbles and a fraction poor in gas microbubbles

f) using a fraction rich in gas microbubbles in part or in whole as a food ingredient p1 g) finishing the preparation of the food product p1 wherein after step d) or e) the pH is adjusted, if adjustment is necessary, such that the pH of the aqueous phase of the food product is from 2.5 to 6.0.

These steps will be described below in more detail.

a) preparing a mixture comprising protein and water

The mixture of protein and water prepared in this step may be a dispersion or preferably a solution.

The proteins used in the mixture may be any capable of forming a coating around gas microbubbles.

Preferred proteins are chosen from the group of globular proteins. Examples of suitable globular proteins are whey proteins, glycinins, conglycinin, potato proteins, pea proteins, transferring and albumins. Other preferred proteins are whey proteins

Especially preferred proteins are chosen from the group of the albumins, transferring and glycinins. Examples of preferred albumins are serum albumins, ovalbumin. An example of a transferrin is conalbumin (also designated as ovo-transferrin) and an example of a preferred glycinin is glycinin 11S.

Of the serum albumins, bovine serum albumin and porcine serum albumin are particularly preferred.

“Protein” is herein defined to include mixtures of proteins and mixtures of protein and other constituents, such as egg white and serum. Crude egg white and egg white powder etc. may be advantageously used according to the invention as protein.

The mixing of protein and water can be done in a known manner. The amount of protein in the mixture should be so high that at least a partial coating around the gas microbubbles is attained. Also the amount should be such that enough microbubbles are attained. The upper limit of the amount may be determined by the dispersibility or solubility of the protein in water. The protein concentration is preferably from 0.1 to 30 wt. %, more preferably from 0.1 to 10 wt. %, most preferably 0.5-8 wt. %. For whey protein, the protein concentration is preferably 0.5-15 wt. %, more preferably 5-10 wt. %.

According to a preferred embodiment, the mixture in step (a) is prepared under stirring until a homogeneous mixture is formed. Homogeneous in this context is meant to indicate that said compound is present in the aqueous phase and essentially no residue is present on the bottom of a jar in which the mixture is prepared if stirring is stopped.

In step a) also other ingredients that are part of the aqueous phase of the final product may be added. Such ingredients are for example water-soluble flavours,dairy ingredients such as buttermilk powder or whey powder, colourants, stabilisers, gelling agents or thickners, salts and the like. Optionally after step a), excess ingredient that has not solubilized but forms a residue is removed by centrifugation or filtration, e.g. ultrafiltration or a similar separation technique.

The pressure in step a) is not critical. Preferably the pressure is from 0.5 to 4 bar, most preferred is atmospheric pressure.

The temperature in step a) is not critical, as long as it is not so high that substantial thermal decomposition of the protein occurs. This temperature depends on the type of protein. Generally preferred temperatures are from room temperature (20° C.) to 80° C., more preferably from 40° C.-60° C.

b) Adjusting the pH of the Mixture to a Value Within the Range of 2.0 to 11.0

The pH of the mixture to be subjected to sonication is found to be important. The desirable pH is adjusted in step b). The following pH ranges for different proteins were found to give the highest microbubble yield.

For serum albumins the preferred pH range is 2.0-9.0, most preferred 2.7-4.1. For egg white protein the preferred pH range is 3.5-4.1. For soy protein the preferred pH range is 5.5-9.0, most preferred the pH is in the range of 6.7-7.3. For conalbumin, the preferred pH range is 8.5-10.5. For whey protein, the preferred pH range is 8.5-10.5.

Adjustment of pH, in step b) but also in other steps herein, may be done in a known manner, e.g. by addition of acid or base. The pH may be measured during step b) in order to allow addition of the right amount of acid or base, for instance by using a pH-meter. Preferably acids or bases are used that are acceptable for addition in food products. The acids may be organic or inorganic. Most preferred acids are citric acid, lactic acid and/or acetic acid. Most preferred bases are sodium hydroxyde.

Temperature and pressure are not critical as long as they are within ranges where no substantial decomposition of the protein occurs.

Step a) and step b) may be combined.

c) Pre-incubating the Mixture

Preferably after step a) and/or b) the protein mixture is subjected to pre-incubation step. The pre-incubation step is a step wherein the mixture allowed to rest for a certain time. The pre-incubation time may be from 1 minute to several hours, preferably from 10 minutes to 2 hours most preferably around 30 minutes in a batchwise process. In a continuous process the comparative incubation times (residence time) are preferred.

The pH of the mixture in step c) may be about the same as at the end of step b). The temperature in the pre-incubation step should be below about 90° C., since at higher temperatures the protein may decompose or polymerise in a way which deteriorates microbubble formation in step d). The optimum pre-incubation temperature is dependent on the type of protein, more specifically related to the denaturation temperature of the protein. Preferably the pre-incubation temperature is 30-90° C. Preferably the pre-incubation temperature is about 2 to 20 degrees lower than the denaturation temperature of the protein, preferably 5-10 degrees lower than this denaturation temperature. Most preferred ranges for the pre-incubation temperature are 45-55° C. for serum albumin, 75-85° C. for glycinin 11S, 60-70° C. for ovalbumin, 35-45° C. for conalbumin and 60-70° C. for beta-lactoglobulin. Denaturation temperatures of a protein or mixtures containing a protein may be determined using circular dichromism techniques, known to the person skilled in the art. Though not wishing to be bound to theory, it is believed that during the pre-incubation step, under the influence of temperature, the protein chains will fully or partly unfold.

d) Subjecting the Mixture to a Sonication Treatment

According to step d) sonication is applied. This step may be carried out by immersing a sonicator tip into the mixture or by putting said mixture in a sonicating bath. For the indicated method of sonication, any sonicator type can be used. Preferably the type of sonicator and the dimension of the sonicator tip or horn are chosen such that they are in accordance with the volume of the mixture that is subjected to sonication.

The sonication treatment can be carried out in the pulsed mode or in the continuous mode, whereby the pulsed mode is preferred. Advantageously flow-through sonicators are used, since these allow continuous operation of the process.

Preferably sonication is carried out under conditions comparable to those of the sonication method as used in the examples, however adapted for industrial scale of the process, based on the knowledge of the person skilled in the art, such as for instance illustrated in EP-B 0359246. According to the method of the examples, the sonicator is of the Branson model 450, with a 0.5 inch probe. A beaker of 150 cm³ is half-filled with the indicated mixture. The power level during sonication is 8 and the duty cycle in pulsed mode is preferably 30%.

It has been found that gas (e.g. air) is easily dispersed in the sonicated mixture if sonication is applied. Through cavitation due to the sonification air may be drawn into the protein containing mixture and microbubbles may be formed.

Alternatively sonication may be conducted under stirring. Stirring is preferably moderate or vigorous, whereby for example 200 to 10.000 rpm is applied for a volume of about 50-500 ml. Preferably stirring is such that a foam is formed on the surface of the sonicated mixture.

Sonication is advantageously conducted in an atmosphere of gas, which may be incorporated in the protein coated microbubbles. For example nitrogen or argon can be present. Also air is a suitable composition for the process of the current invention.

According to a further embodiment the mixture is sparged with a suitable gas or mixture of gases as indicated above. Sparging can be carried out at any time during the preparation steps a) to d) according to the invention. Thus said sparging can be carried out before sonicating said aqueous mixture to saturate the mixture with said gas composition (e.g. in step a)) or during sonication (in step d)). A combination of these methods is also possible.

Sonication may be carried out under atmospheric pressure. It is also possible to work under reduced or increased pressure. However care should be taken that the sonication conditions are chosen such that the gas microbubbles that are formed in the product according to the invention do not collapse due to overpressure and do not burst due to under-pressure.

In a preferred process, if a certain pressure is applied during preparation of the aqueous phase, said pressure is remained throughout additional process steps. Preferably in step d) a pressure of from 0.5 to 4 bar, preferably from 0.8 to 2.5 bar, most preferred atmospheric or near atmospheric pressure is applied. Said pressure can be created using any of the gas compositions as indicated above.

Though sonication may in principle be carried out at any given temperature, it will be appreciated that the presence of heat sensitive compounds, like proteins, should be taken into account when choosing the desired temperature. Preferably sonication is carried out around temperatures below the denaturation temperature of proteins if there are any proteins present; this to overcome denaturation and subsequent precipitation of said proteins.

Preferably in step d) said mixture is at a temperature of from 30-90°C., preferably from 35-70°C. Especially suitable temperatures of sonication are from 50 to 74° C. for soy proteins and for ovalbumin and 45 to 55° C. for egg white protein and serum albumins, and 55 to 70° C. for whey protein, since at these temperatures high yields of microbubbles are obtained.

Preferably the amount of gas microbubbles in the starting material after sonication is such that the aqueous phase comprises from 1 exp07 to 2 exp12 gas microbubbles per cm³.

The gas microbubble mean diameter size distribution in the sonicated material is preferably in accordance with the distribution desired for the final product.

Therefore an average diameter of about 2 to 5 μm is desired for a sonicated emulsion which will be applied in a frying product that shows reduced spattering. More increased average size distribution is possible if the material is applied in a pourable product.

The aqueous phase with gas microbubbles prepared in step d) can be used as such but it can also be combined with further ingredients of the aqueous phase followed by combination with other ingredients, for example a fatty phase and/or any of the other ingredients that are suitable ingredients for food products according to the invention, such as those indicated above.

e) Optionally, Separating the Product of Step d) in a Fraction Rich in Gas Microbubbles and a Fraction Poor in Gas Microbubbles

The mixture with gas microbubbles prepared in step d) may optionally be subjected to centrifugation, (ultra)filtration or similar separation techniques. The separation step is optionally preceded by a resting treatment. During such a resting treatment the aqueous phase is preferably stored at a temperature of from 0 to 15° C., whereby the larger gas microbubbles are allowed to float to the surface of the system. Said larger bubbles can be removed by decantation. The resulting aqueous mixture, which comprises relatively small gas microbubbles may then be centrifuged at low velocity for example around 800 rpm. In such a centrifuging treatment gas microbubbles are concentrated in the upper part of the system and water comprising an increased amount of gas microbubbles can easily be decanted. Herewith an aqueous mixture with an increased content of relatively small gas microbubbles can be obtained. Moreover by this treatment compounds such as protein that does not participate in the gas microbubble coating can be separated out.

The separation step e) may be executed in such way that more than one subfraction rich in gas microbubbles are obtained and/or more that one subfractions poor in gas microbubbles are produced. Subfractions rich in microbubbles may be mixed with one another, as may fractions poor in gas microbubbles, before further processing.

Preferably the fraction poor in gas microbubbles is recycled to step a) or b). We have found that recycled protein in the fraction poor in gas microbubbles is still suitable for the preparation of gas microbubbles. We have found that at least five times recycling is possible. Recycling considerably increases the economy of the process, because protein losses are minimized.

Step e) may be omitted in case the product of step d) has such composition that it can directly be used in the preparation of a food product.

f) Using a Fraction Rich in Gas Microbubbles in Part or in Whole as a Food Ingredient

The fraction rich in gas microbubbles prepared in step e) or the product of step d) can be used as a food ingredient. The fraction rich in gas microbulles may be added to other food ingredients during the preparation of a food product, in a known way, e.g. by mixing.

The fraction rich in gas microbubbles is added to the aqueous phase of a food product. The aqueous phase may consist wholly or partly of the aqueous mixture prepared in step e).

Advantageously an edible salt chosen from group I or group II salts or ammonium salts is added. The edible salt may be added in any of steps a) to g). Preferably the salt is added in step e) or f) or g), since if the salt is added before the protein is dissolved, the protein solubility in the mixture of protein and water will be lower. The salt is preferably and edible salt from group II or ammonium halides, sulphates, phosphates or citrates and more preferably the edible salt is sodium chloride.

The amount of edible salt is preferably 0.1-10 wt. %, based on the total weight of the food product, more preferably 0.5 to 5 wt %, most preferably 0.5 to 2 wt %.

Surprisingly, the edible salt increases the stability and anti-spattering performance of food products according to the invention. We have observed that when the salt is added to emulsions with protein coated microbubbles at pH of 2.5-6.0, the protein microbubbles form aggregates, observable under the microscope as lump-like structures in which multiple protein coated microbubbles are connected to each other in some way.

g) Finishing the Preparation of the Food Product Step g) may be Conducted According to Methods Known to the Person Skilled in the Art.

Food products according to the invention may be spreads, margarines (water in oil or oil in water emulsions), mayonnaises (oil in water emulsions), dairy products such as fresh cheese (oil in water emulsions) and dressings (oil in water emulsions).

For example margarines may be prepared by using a votator process. Cheese can be prepared by for example a standard soft cheese or fresh cheese production process.

A preferred step g), for the preparation of a liquid margarine, comprises melting triglyceride oil in shear mixer such as an A unit, cooling to below the alpha crystallisation temperature and subsequent, or prior to cooling, mixing the triglyceride oil with the an aqueous phase. The resulting product is preferably stored at a temperature from 0 to 15° C.

According to another embodiment the obtained aqueous phase, comprising the gas microbubbles is used for the preparation of a spreadable margarine or margarine like product, e.g. comprising from 30 to 95 wt. % fat. A preferred process to prepare such a spreadable margarine or margarine like product comprises the steps of emulsification of aqueous phase in a melted fatty phase, mixing the formed emulsion to ensure uniformity, cooling said emulsion in a shear unit, for example a tubular scraped surface heat exchanger, to obtain crystallisation, working the resulting partially crystallised emulsion in for example a pin stirrer unit and packaging the resulting fat continuous product. Optionally before packaging the emulsion is subjected to a resting treatment to increase the final product consistency. Said resting is for example carried out in a resting unit or a quiescent tube.

In steps e) to g) the pH may be adjusted, in case the pH is not yet within the range of 2.5 to 6. We have found that the optimum pH for production of gas microbubbles may be different from the pH for optimum stability in the food product. The adjustment can be done by addition of acid or base as described under b).

Preferably, when the protein is a serum albumin, the pH of the aqueous phase is adjusted to a value from 2.5 to 4.8, when the protein is egg white protein, the pH of the aqueous phase is adjusted to a value from 3.5 to 4.1 and when the protein is glycinin the pH is adjusted to a value of 6.0 or lower. For whey protein the pH of the aqueous phase is not critical, since whey protein coated gas microbubbles are stable over a broad range of pH's.

The pH in the aqueous phase of a food product being an emulsion is determined as follows. The aqueous phase is separated from the oil phase by heating the food product to 90° C. for 45 minutes and then centrifuging the heated food product at 2800 rotations per minute for 5 minutes. The emulsions are separated due to this treatment into a distinct aqueous phase and a distinct oil phase. The phases were separated through decantation and the pH of the aqueous phase was measured with a pH measuring probe connected to a pH meter. Salt content can be analysed using elemental analysis.

In food products according to the invention the protein coated gas microbubbles can be detected, e.g. by microscopic techniques as described in the experimental part hereof. The type of protein in the gas microbubbles may be determined by amino-acid sequence analysis.

The invention is now illustrated by the following non-limiting examples.

### EXAMPLES

Determination of Spattering Value in a Spattering Test

Primary spattering (SV1) was assessed under standardised conditions in which an aliquot of a food product was heated in a glass dish and the amount of fat spattered onto a sheet of paper held above the dish was assessed after the water content of the food product had been evaporated by heating.

Secondary spattering (SV2) was assessed under standardised conditions in which the amount of fat spattered onto a sheet of paper held above the dish is assessed after injection of a quantity of 10 ml water into the dish.

In assessment of both primary and secondary spattering value, 25 g food product was heated in a 14 cm diameter glass dish on an electric plate set at 205° C. The fat that spattered out of the pan by force of expanding evaporating water droplets was caught on a sheet of paper situated at 25 cm above the pan (SV1 test). Subsequently a quantity of 10 ml water was injected into the dish and again the fat that spattered out of the pan by force of expanding evaporating water droplets was caught on a sheet of paper situated above the pan (SV2 test).

The images obtained were compared with a set of standard pictures number 0-10 whereby the number of the best resembling picture was recorded as the spattering value. 10 indicates no spattering and zero indicates very bad spattering. The general indication is as follows.

| Score | Comments |
|---|---|
| 10 | Excellent |
| 8 | Good |
| 6 | Passable |
| 4 | unsatisfactory for SV1, |
| | almost passable for SV2 |
| 2 | very poor |

Typical results for household margarines (80 wt. % fat) are 8.5 for primary spattering (SV1) and 4.6 for secondary spattering (SV2) under the conditions of the above mentioned test, directly after preparation of the household margarines. The samples at pH 3.5 have a good storage stability and a good storage stability with respect to anti-spattering performance.

Microscopic Method

Description of the procedure to visualise gas microbubbles in the water phase of a water in oil emulsion. The microscope that has been used to visualise the gas microbubbles in the water phase is a confocal scanning light microscope (CSLM). This instrument is commercially available from a variety of manufactures. The basic principle of CSLM is that in a bulk specimen a stack of in focus slices can be obtained resulting in a 3-D image data set. The microscopy mode is based on visualisation of fluorescently labeled features. To visualise the gas microbubbles a fluorescent dye is brought into contact with the emulsion. The dye diffuses into the emulsion and based on the high affinity of the dye for proteins it is almost exclusively present at the proteins after some time allowing the observation of the protein in the emulsion using CSLM. Since the gas microbubbles are surrounded by a protein layer these gas microbubbles show up in the water droplets as spherical features in which a black hole, being the gas, can be discerned. For the included pictures, the spatial resolution of the light microscope is limited to approximately 0.5 μm. This means that the black hole is not visible in gas microbubbles that are smaller than approximately 1 μm.

Procedure for visualisation

Approximately 1 g of the emulsion was mixed or shaken gently with 1 drop of the fluorescent dye Rhodamin (0.1% w/v in water), until the Rhodamin solution was completely dispersed in the emulsion. Rhodamin diffuses both through the oil phase and the water phase and is accumulated at proteins and particulate material like emulsifiers. The fluorescent dye was also present at low concentration in the aqueous phase, which resulted in a weak fluorescent signal from the aqueous phase. This allowed localisation and identification of the water droplets in the emulsion.

Part of the stained emulsion was placed in a suitable bulk sample holder that allows observation of an undisturbed not-squeezed part of the emulsion. Using the conical microscope a stack of optical slices were collected. Typical instrumental conditions are optical sections separated 0.5 μm in z-direction using a high magnifying objective lens (for instance 63 times, 1.3 N.A. oil immersion).

Measurement of the Average Mean Diameter of Gas Microbubbles and Microbubble Yield

The number of protein coated gas microbubbles in the water phase was determined as follows:

The microbubble solution is put in a microscopic counting chamber; layer thickness 10 μm.

The microscope is a Zeiss Axioplan 2 using phase contrast. Using this phase contrast option the microbubbles become visible as bright spots. The magnification is 40×1.6×0.63 (objective is 40×). The image is recorded with Sony video camera.

The monitor picture is captured with video capture software using a capture card in a PC. With Image Pro Plus (image analysis software) this captured image is analysed. The number of gas microbubbles is determined using the count/size option of the measurement tool of the software.

The amount of microbubbles counted at a 40× magnitude, using the 0.01 cm counting chamber was divided by the microscopic field volume (2.83×10⁻⁷ ml) which resulted in the amount of microbubbles/ml. For each sample the microbubble were counted 10 times, and the average of the 10 counts was taken as value for microbubble yield.

### EXPLANATION OF THE DRAWINGS

FIG. 1 Microbubble production and stability measured at different pH X-axis shows pH, Y-axis the number of gas microbubbles (divided by 1*10e9) counted in 1 milliliter food product according to example 2. ▪ At t(0) ♦ At 24 hours

### Example 1

Protein coated microbubbles were produced by a pulse-wise sonification of a 15 ml solution of 5% w/v bovine serum albumin (Acros 24040) in demi water (pH 7). Prior to the sonification procedure the solution was pre-incubated for 30 minutes at 50° C. Sonification was carried out at 500° C. for 1.5 minutes, using a Branson 450 sonicater with 1 cm probe (power level 10, duty cycle 50%). During sonification the albumin solution was not stirred. Production of microbubbles at low pH was performed after adding citric acid to the albumin solution to adjust the pH.

Liquid margarine emulsions (78% Sunflower oil, 2% RPhe70, 20% demi water +/− microbubbles) were made with the microbubble solutions at different pH. RPhe70 is a rape triglyceride having a high content of C22 fatty acid, commercially available from Quest. After the emulsions had stabilised, 1.5% NaCl was added in those samples containing NaCl (see table 1).

TABLE 1
Spattering values of samples prepared according to
example 1.

| | Micro- | | | NaCl | 1 day | | 3 weeks | | 6 weeks | |
|---|---|---|---|---|---|---|---|---|---|---|
| Sample No. | bubbles? | PH1 | pH2 | (%) | SV1 | SV2 | SV1 | SV2 | SV1 | SV2 |
| 1 | No | 7.0 | 7.0 | 0 | 5 | 0 | 5 | 0 | 5 | 0 |
| 2 | Yes | 7.0 | 7.0 | 0 | 10 | 5.5 | 8.5 | 0 | 6 | 0 |
| 3 | Yes | 7.0 | 7.0 | 1.5 | 10 | 7 | 7 | 6 | 8 | 0 |
| 4 | No | 3.5 | 3.5 | 0 | 0 | 0 | 0 | 0 | 0 | 0 |
| 5 | No | 3.5 | 3.5 | 1.5 | 8.5 | 3 | 8.5 | 3 | 8.5 | 3 |
| 6 | Yes | 3.5 | 3.5 | 0 | 10 | 6.5 | 10 | 7 | 10 | 6.5 |
| 7 | Yes | 3.5 | 3.5 | 1.5 | 10 | 9 | 10 | 9 | 10 | 8.5 |
| 8 | Yes | 3.5 | 4.1 | 0 | 10 | 7 | 10 | 7 | 10 | 7 |
| 9 | Yes | 3.5 | 4.8 | 0 | 9.5 | 5.5 | 9.5 | 5.5 | 9.5 | 4.5 |

Notes:
pH1 is pH during production of microbubbles
pH2 is pH in product emulsion
Samples 1, 4 and 5 contain 5% w/v, untreated (not sonicated) bovine serum albumin

Example 1 shows that at low pH value (pH=3.5) compared to neutral pH value (pH=7), the SV values after 3 weeks and 6 weeks are considerably improved, especially SV2. The SV2 values are already better after 1 day of storage. The data thus indicate an improved storage stability, with respact to anti-spattering performance.

Microsopic study revealed that the gas microbubbles have a long-term stability in the product.

The addition of salt further improves the spattering values.

Samples 1, 4 and 5 are comparative samples without microbubbles. These samples result in bad spattering values.

### Example 2

Production of microbubbles and stability after 24 hours at different pH

Microbubbles were produced according to the procedure described in example 1. Production of microbubbles at low pH was performed by adding citric acid to the albumin solution. Production at high pH was performed by the addition of NaOH to the albumin solution. The number of microbubbles was counted directly after the production (to) and after 24 hours storage at 4° C.

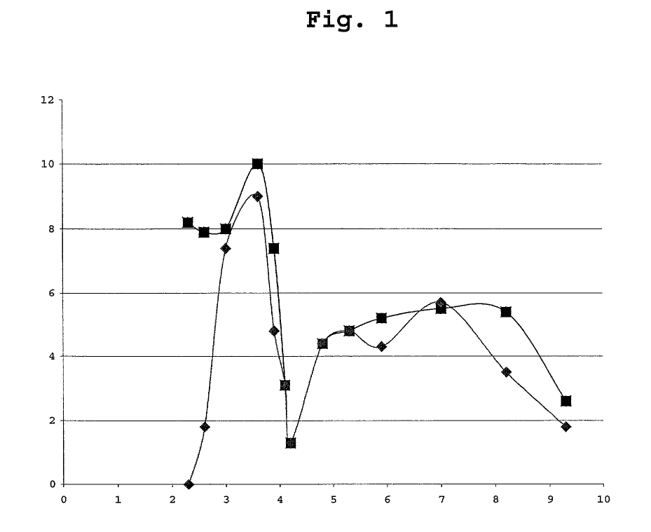

The results are presented in table 2 and FIG. 1

TABLE 2
Microbubble production and stability at different pH

| | | Microbubble | |
|---|---|---|---|
| | | production | Stability |
| | | (microbubbles/ml | (Microbubbles/ |
| | | directly after | ml, 24 hours |
| Sample | pH | production) | after production) |
| 10 | 2.3 | 8.2 e9 | 0 |
| 11 | 2.6 | 7.9 e9 | 1.8 e9 |
| 12 | 3.0 | 8.0 e9 | 7.4 e9 |
| 13 | 3.6 | 1.0 e10 | 9.0 e9 |
| 14 | 3.9 | 7.4 e9 | 4.8 e9 |
| 15 | 4.1 | 3.1 e9 | 3.1 e9 |
| 16 | 4.2 | 1.3 e9 | 1.3 e9 |
| 17 | 4.8 | 4.4 e9 | 4.4 e9 |
| 18 | 5.3 | 4.8 e9 | 4.7 e9 |
| 19 | 5.9 | 5.2 e9 | 4.3 e9 |
| 20 | 7.0 | 5.5 e9 | 5.7 e9 |
| 21 | 8.2 | 5.4 e9 | 3.5 e9 |
| 22 | 9.3 | 2.6 e9 | 1.8 e9 |

Example 2 shows a peak in the amount of microbubbles at around 3.6. At low pH values, i.e. below pH=3, the initial amount of microbubbles is high, but the stability of the microbubbles is low (see data of samples 10 and 11).

A dip in microbubble production is seen at pH 4.2.

### Example 3

Different protein sources for microbubble production

Microbubbles were produced according to the procedure described in example 1. Production of microbubbles at low pH was performed by adding citric acid to the albumin solution. Different proteins were used to produce the protein coated microbubbles. The results are given in table 3. Pre-incubation time and sonication time vary for each protein source used as indicated.

TABLE 3
Different protein sources for microbubble production

| | | | | | | | Micro- |
|---|---|---|---|---|---|---|---|
| | | | T1 | T2 | τ1 | τ2 | Bubbles/ |
| Sample | Source | pH | ° C. | ° C. | (min) | (min) | ml |
| 23 | Bovine serum | 3.6 | 50 | 50 | 30 | 1.5 | 1.0 e10 |
| | albumin (Acros | | | | | | |
| | 24040) | | | | | | |
| 24 | Porcine serum | 3.5 | 50 | 50 | 30 | 1.5 | 1.4 e10 |
| | albumin (SIGMA | | | | | | |
| | A1830) | | | | | | |
| 25 | Crude egg-white | 3.6 | 50 | 50 | 30 | 1.5 | 2.7 e9 |
| | powder (JT | | | | | | |
| | BAKER, 1002) | | | | | | |
| 26 | Crude egg-white | 3.8 | 50 | 50 | 30 | 1.5 | 2.7 e9 |
| | powder (High | | | | | | |
| | Whip 788, | | | | | | |
| | van Enthoven) | | | | | | |
| 27 | Untreated crude | 3.8 | 50 | 50 | 30 | 1.5 | 2.7 e9 |
| | egg-white powder | | | | | | |
| | from fresh eggs | | | | | | |
| 28 | Ovalbumin | 7 | 50 | 75 | 30 | 0.3 | 3.6 e8 |
| | (Sigma A5503) | | | | | | |
| 29 | Conalbumin, Fe | 3.9 | 50 | 50 | 30 | 1.5 | 1.3 e9 |
| | complex (Sigma | | | | | | |
| | C0880) | | | | | | |
| 30 | Conalbumin, Fe | 3.7 | 50 | 50 | 30 | 1.5 | 1.1 e8 |
| | free (Sigma | | | | | | |

Notes:
T1 is temperature during pre-incubation (° C.),
τ1 is pre-incubation time (minutes)
T2 is temperature during sonication (° C.),
τ2 is sonication time (minutes)

Example 3 shows that protein coated microbubbles can be produced using bovine serum albumin, porcine serum albumin, egg-white, ovalbumin,and conalbumin.

### Example 4

Microbubbles were produced according to the procedure described in example 1, however egg white protein powder (JT BAKER 1002) was used instead of bovine serum albumin. Production of microbubbles at low pH was performed by adding citric acid to the albumin solution. Production at high pH was performed by the addition of NaOH to the albumin solution. The number of microbubbles was counted directly after the production (to).

The results are given in table 4.

TABLE 4
Microbubble production at different pH using crude
egg white protein powder (JT BAKER 1002)

| | | Microbubbles/ |
|---|---|---|
| Sample | pH | ml at (t0) |
| 31 | 2.0 | 0 |
| 32 | 3.0 | 0 |
| 33 | 3.6 | 1.8 e9 |
| 34 | 3.9 | 1.4 e9 |
| 35 | 4.1 | 8.8 e8 |
| 36 | 5.0 | 0 |
| 37 | 6.0 | 0 |
| 38 | 7.0 | 0 |
| 39 | 9.0 | 0 |

### Example 5

Liquid margarines were prepared as in example 1 using the aqueous phase with microbubbles prepared in example 4, sample 26. Two comparative samples 40 and 41 without microbubbles were included in the test. The spattering behaviour of the resulting liquid margarines was measured. The results are given in table 5.

TABLE 5
Spattering values for liquid margarines with egg-
white protein coated microbubbles of example 5.

| | Micro- | | | NaCl | 1 day | | 3 weeks | | 6 weeks | |
|---|---|---|---|---|---|---|---|---|---|---|
| Sample No. | Bubbles? | PH1 | pH2 | (%) | SV1 | SV2 | SV1 | SV2 | SV1 | SV2 |
| 40 | No | 3.5 | 3.5 | 0 | 5.5 | 1 | 5.5 | 1 | 6 | 0 |
| 41 | No | 3.5 | 3.5 | 1.5 | 6.5 | 7 | 7 | 6 | 8 | 5.5 |
| 42 | Yes | 3.5 | 3.5 | 0 | 10 | 5 | 10 | 5 | 10 | 5 |
| 43 | Yes | 3.5 | 3.5 | 1.5 | 10 | 8 | 10 | 8 | 10 | 8.5 |
| 44 | Yes | 3.5 | 7.0 | 1.5 | 9.5 | 6.5 | 8.5 | 5.5 | 8.5 | 6.0 |

Notes:
pH1 is pH during production of microbubbles
pH2 is pH in product emulsion
Samples 40 and 41 contain 5% w/v, untreated egg white

Example 5 shows that liquid margarines with egg-white protein coated microbubbles and pH of the aqueous phase of 3.5 have improved spattering values compared to liquid margarines without microbubbles. Comparison of samples 43 and 44 shows that when the pH in the product emulsion is 3.5 instead of 7.0 the anti-spattering performance is considerably improved.

### Example 6

Recycling of protein

Microbubbles were produced according to the procedure described in example 1 at pH 7 using bovine serum albumin (Acros 24040). After each sonication step microbubbles were removed by centrifigation (30′ at 15,000 g) and the non-incorporated albumin was re-used in sonication. Albumin decrease and microbubble yield was measured after each of 5 recycling steps.

TABLE 6
Microbubble yield and albumin concentration
in recycling experiment (example 6)

| | Microbubble yield | [Albumin] |
|---|---|---|
| | (microbubbles/ml) | in mg/ml |
| Before ultrasonic | — | 49.23 |
| treatment | | |
| After 1 ultrasonic | 6.4 e9 | 44.97 |
| treatment | | |
| After 2 ultrasonic | 5.3 e9 | 43.41 |
| treatments | | |
| After 3 ultrasonic | 6.4 e9 | 43.29 |
| treatments | | |
| After 4 ultrasonic | 7.7 e9 | 42.69 |
| treatments | | |
| After 5 ultrasonic | 4.8 e9 | 41.13 |
| treatments | | |

[Albumin] is concentration of free Albumin in solution (mg/ml), which was measured spectrophotometrically at 280 nm.

### Examples 7-10 and Comparative Examples A, B and C

(a) Dialysis of Whey Protein Solutions.

A protein solution (10% w/v of Ultra Whey 99, available from Volactive (UK)) was dialysed using a hollow fiber membrane (Hemofilter Pan 06 from Asahi Medical Co. LTD, MWCO 5,000 Dalton) during 3 hours at 4° C. against demineralized water. In case the solutions were diluted due to the dialysis, they were concentrated up to 7.5% w/v using a concentrating cell (Amicon) containing an ultrafiltration membrane (Diaflo PM10). This dialysed whey solution was used in examples 7-15.

(b) Production of Microbubbles by Sonication

15 ml of a dialysed 7.5% w/v whey protein solution in demi water was adjusted to pH 9.5 using 0.2 M NaOH. The solution was pre-incubated for 15 minutes at 65° C. and subsequently sonicated at 50° C. for 45 seconds, pulse-wise using a Branson 450 sonicator with 0.5 inch probe (power level 10, duty cycle 50%).

(c) Preparation of a Liquid Margarine Comprising Protein Coated Gas Microbubbles

A liquid margarine emulsion was made having the following composition: 78 wt. % sunflower oil, 2 wt. % hardstock fat, 20 wt. % demineralized water with microbubbles as prepared under (b). The hardstock fat was a rapeseed oil, hydrogenated until a slip melting point of 70° C. After the emulsions had stabilised, 1.5% NaCl was added in those samples containing NaCl (see table 1).

For comparison, in comparative examples A, B, and C, liquid margarines without added microbubbles were prepared as indicated above under (c).

The stability of the samples (SV values) was tested after storage of the samples at 15° C., after the time intervals indicated in table 7.

TABLE 7
Spattering values after different storage times for
liquid margarine, for examples 1-4 and comparative examples A-
C, varying pH and salt (NaCl) concentration. MB denotes:
Microbubbles

| | | pH | NaCl | 1 day | | 3 weeks | | 6 weeks | |
|---|---|---|---|---|---|---|---|---|---|
| Ex. | MB | emulsion | (%) | SV1 | SV2 | SV1 | SV2 | SV1 | SV2 |
| A | no | 9.5 | 0 | 6.5 | 1 | 6.5 | 2 | 6 | 1.5 |
| B | no | 4.5 | 0 | 5.5 | 6.5 | 2 | 6 | 4 | 6 |
| C | no | 4.5 | 1.5 | 6 | 7 | 5.5 | 6.5 | 5.5 | 6 |
| 7 | yes | 4.5 | 0 | 10 | 7.5 | 10 | 7.5 | 10 | 7.5 |
| 8 | yes | 4.5 | 1.5 | 10 | 8.5 | 10 | 8.5 | 10 | 8.5 |
| 9 | yes | 4.0 | 0 | 10 | 6.5 | 10 | 6.5 | 10 | 6.5 |
| 10 | yes | 4.0 | 1.5 | 10 | 8 | 10 | 8.5 | 10 | 8.5 |

These examples show that whey protein coated gas microbubbles have good anti-spattering properties. These properties remain after storage of 6 weeks.

Example 11

Temperature Stability of Protein Coated Gas Microbubbles

As a microbubble solution is turbid, the breakdown of the microbubble structure upon heating can be measured by reading the absorption decrease at 600 nm. Microbubbles made from whey, soy glycinin and serum albumin were compared this way. Results, in % turbidity, are depicted in Table 8. Two control experiments were carried out. The protein solutions without microbubbles do not show turbidity up to 80° C., indicating no contribution of temperature induced protein aggregation. Also, the microbubble concentration, different for each kind of protein, does not have an influence on the temperature profiles (data not shown).

TABLE 8
Temperature stability of the microbubble shell
structure measured by reading the turbidity at 600 nm.
Turbidity at 25° C. is set 100%.

| | | glycinin | |
|---|---|---|---|
| temperature | albumin-based | 11S-based | whey-based |
| in ° C. | microbubbles | microbubbles | microbubbles |
| 25 | 100 | 100 | 100 |
| 30 | 98 | 88 | 99 |
| 35 | 96 | 82 | 98 |
| 40 | 93 | 76 | 96 |
| 45 | 87 | 70 | 94 |
| 50 | 76 | 62 | 92 |
| 55 | 58 | 52 | 88 |
| 60 | 39 | 42 | 81 |
| 65 | 28 | 34 | 74 |
| 70 | 19 | 29 | 69 |
| 75 | 15 | 25 | 63 |
| 80 | 14 | 22 | 59 |

Table 8 shows that whey protein coated gas microbubbles are more stable than other protein coated gas microbubbles.

### Examples 12-15

Stability of Microbubbles Against Emulsifier

The stability of protein coated gas microbubbles in a 80 wt. % fat emulsion was tested for different proteins coated microbubbles. A 80 wt. % fat water-in-oil emulsion was prepared as in example 1 with 78 wt. % sunflower oil, 2 wt. % hardstock as in example 1 and 20 wt. % water with 1 wt. % microbubbles. The pH the water phase was pH 7. No other additives, like lecithin salt were added. The spattering results are given in table 9

TABLE 9
Spattering results in a 80 wt. % fat emulsion

| | |
|---|---|
| after 1 day | after 6 weeks |

| Ex. | Composition | SV1 | SV2 | SV1 | SV2 |
|---|---|---|---|---|---|
| 11 | albumin-based | 10 | 5.5 | 6 | 0 |
| | microbubbles | | | | |
| 12 | glycinin 11S-based | 7 | 5 | 6.5 | 5 |
| | microbubbles | | | | |
| 13 | egg white based | 10 | 6.5 | 8.5 | 5 |
| | microbubbles | | | | |
| 14 | whey-based | 10 | 7 | 10 | 7 |
| | microbubbles | | | | |

Table 9 shows that whey protein coated gas microbubbles are more resistant to emulsifiers than other protein coated gas microbubbles.

1. Food product comprising an aqueous phase and gas microbubbles substantially dispersed in the aqueous phase which gas microbubbles have a coating and a mean diameter size distribution with a maximum below 10 μm, wherein the coating substantially consists of protein, characterized in that the pH of the aqueous phase is from 2.5 to 6.0.

2. Food product according to claim 1, wherein the protein is one or more proteins chosen from globular proteins.

3. Food product according to claim 2, wherein the protein is one or more proteins chosen from the group of albumins, transferrins or glycinins.

4. Food product according to claim 3, wherein the protein is one or more albumins chosen from serum albumins.

5. Food product according to claim 1, wherein the protein is egg white.

6. Food product according to claim 1, wherein the protein is bovine serum albumin and the pH of the aqueous phase is from 2.5 to 4.8.

7. Food product according to claim 1, wherein the protein is egg white protein and the pH of the aqueous phase is from 2.5 to 5.

8. Food product according to claim 1, wherein the protein is glycinin 11S and the pH of the aqueous phase is 6.0 or lower.

9. Food product according to claim 1, wherein a substantial part of the gas microbubbles is present in the form of aggregates.

10. Food product according to claim 9, wherein at least 80 wt. % of the gas microbubbles is present in the form of aggregates.

11. Food product according to claim 1, wherein the aqueous phase comprises an edible salt chosen from group I or group II salts or ammonium salts.

12. Food product according to claim 11, wherein the edible salt is chosen from group I or group II or ammonium halides, sulphates, phosphates or citrates.

13. Food product according to claim 12, wherein the edible salt is sodium chloride.

14. Food product according to claim 11, wherein the amount of edible salt is 0.1-10 wt. %, based on the total weight of the food product.

15. Food product according to claim 1, wherein the food product is a water and oil comprising emulsion.

16. Food product according to claim 15, wherein the water and oil comprising emulsion comprises a continuous oil phase and a dispersed aqueous phase.

17. Process for the preparation of a food product comprising the steps of:
a) preparing a mixture comprising protein and water
b) adjusting the pH of the mixture to a value within the range of 2.0-11.0
c) pre-incubating the mixture
d) subjecting the mixture to a sonication treatment
e) optionally, separating the product of step d) in a fraction rich in gas microbubbles and a fraction poor in gas microbubbles
f) using a fraction rich in gas microbubbles in part or in whole as a food ingredient
g) finishing the preparation of the food product.

18. Process according to claim 17, wherein after step d) the pH is adjusted, if adjustment is necessary, such that the pH of the aqueous phase of the food product is from 2.5 to 6.0.

19. Process according to claim 17, wherein after step d) an edible salt according to one or more of claims 11-13 is added to the fraction rich in gas microbubbles.

20. Process according to claim 17, wherein the fraction poor in gas microbubbles is recycled to step a).

21. Protein coated gas microbubbles, wherein the coating of the microbubbles substantially consists of whey protein.

22. Protein coated gas microbubbles according to claim 21, wherein the coating of the microbubbles substantially consists of whey protein of which the lactose content is 10 wt. % or lower, preferably 4 wt. % or lower.
